(19) United States
(12) Patent Application Publication
(10) Pub. No.: US 2019/0217398 A1
(43) Pub. Date: Jul. 18, 2019

(54) Lathe toolrest

(71) Applicant: Joseph B. Glassford, Sunriver, OR (US)

(72) Inventor: Joseph B. Glassford, Sunriver, OR (US)

(21) Appl. No.: 15/732,964

(22) Filed: Jan. 12, 2018

(51) Int. Cl. B23B 29/04

(52) U.S. Cl. CPC B23B 29/04

(57) ABSTRACT

A toolrest for adjustable mounting within a receiving portion of a lathe tool carriage includes a vertical post portion rotatably mounted about a vertical axis, a first substantially horizontal member extending at an angle relative to the vertical post portion and a second substantially horizontal member extending at an angle relative to the first substantially horizontal member. In use, the first and/or second substantially horizontal members are positioned so that a plurality of toolrest positions and angles are provided relative to a workpiece.

### FIELD OF THE INVENTION

The present invention relates in general to a toolrest for use on woodturning lathes and specifically to a toolrest capable of being adjusted to a plurality of angles and positions relative to a workpiece.

### BACKGROUND OF THE INVENTION

A lathe is commonly used to shape objects or workpieces. A lathe holds a workpiece as the workpiece is rotated at relatively high speed. Tools such as cutting and shaping tools are held in contact with the rotating workpiece to shape the workpiece. A lathe may be used to form spindles, table legs, bowls or the like. Lathes may be used to shape wood, metal or other materials.

The basic lathe includes a chuck and a tail piece which can be adjusted towards one another and against the workpiece, the chuck and tail piece being rotated about a central horizontal axis extending through the workpiece. The chuck is powered by a motor which rotates the chuck and the workpiece, typically at high speed. The chuck is adjusted to firmly engage the workpiece so that the workpiece can be supported and shaped. The workpiece is released by adjusting the chuck so the shaped workpiece can be removed from the lathe. The chuck typically includes grasping elements that move towards and away from one another symmetrically about the central horizontal axis of the chuck.

Most lathes include a horizontal base with rails mounted on the base to allow positioning of a lathe tool carriage. Conventional toolrests are mounted on the lathe tool carriage to provide the operator with a stable platform on which to engage the tool to the workpiece. The position of the lathe tool carriage can be adjusted to position the toolrest relative to the workpiece.

A tool support mounted on the lathe tool carriage and positioned adjacent the workpiece serves to steady a tool which can be moved radially toward the rotating workpiece and axially along the length of the workpiece. Rotation of the workpiece accompanied by proper tool location thereby removes material for shaping the workpiece according to the required pattern.

One problem operators experience with conventional toolrests is the limited range of motion available for engaging the tool to the workpiece. Prior solutions are described in U.S. Pat. Nos. 2,888,786; 5,224,529 and 5,992,482.

U.S. Pat. No. 2,888,786 to Place discloses a multi-component toolrest comprising an L-shaped bar including a vertical portion and a horizontal portion extending at a right angle therefrom. A shelf is movably mounted along the horizontal portion to provide support for the tool. It would be desirable to allow the operator to increase the range of motion of the tool. It would also be desirable to provide a toolrest with a one-piece construction to reduce the possibility of parts of the toolrest becoming disengaged during use which could result in damage to the workpiece or injury to the operator.

U.S. Pat. No. 5,224,529 to Kenny discloses a multi-component lathe tool and toolrest assembly wherein a cutting blade is attached at one end of a blade mounting shaft and a handle is attached at the other end of the blade mounting shaft. The handle is used to manipulate the tool to hollow out the core of a workpiece mounted on a lathe for the construction of nesting bowls. It would be desirable if the Kenny toolrest provided the operator with an increased range of motion. It would also be desirable if the Kenny toolrest was manufactured from a one-piece construction to decrease the possibility of injury to the operator or damage to the workpiece if the movable parts became disengaged during use.

U.S. Pat. No. 5,992,482 to Voisey discloses a multi-component toolrest wherein a first horizontally-projecting arm is rotatably mounted about a first vertical axis and a second horizontally-projecting arm is rotatable about a second vertical axis. The first horizontally-projecting arm may be coincident with or spaced horizontally from the second horizontally-projecting arm. A cutting tool may be placed on either the first horizontally-projecting arm or the second horizontally-projecting arm. It would be desirable if the Voisey toolrest comprised a single-piece construction to prevent parts from becoming disengaged during use and injuring the operator or damaging the workpiece.

The foregoing toolrests allow the operator to employ the tool from a limited number of positions. It would be beneficial to provide a toolrest capable of engaging the workpiece from a wide range of positions and angles. In particular, it would be beneficial to provide a toolrest that allows the operator to move a tool from one portion of the workpiece to another portion of the workpiece with minimal adjustment of the toolrest so that the workpiece can be engaged seamlessly from a broad range of positions and angles.

### SUMMARY OF THE INVENTION

The present invention provides an improved toolrest that allows the operator to engage the workpiece from a plurality of angles and positions. A preferred embodiment of the toolrest includes a vertical post portion adapted for vertical and rotational movement within a receiving portion, a first substantially horizontal member extending at a first angle relative to the vertical post portion, and a second substantially horizontal member extending at a second angle relative to the first substantially horizontal member. The first and second angles are preferably about 90 degrees. By adjustably mounting the toolrest within the receiving portion, the first and second substantially horizontal members define a plurality of toolrest positions relative to the workpiece.

The vertical post portion can include an adjustable collar for engaging the receiving portion to define the extent of travel of the vertical post portion within the receiving portion. The vertical post portion includes a first end and a second end, the first end adapted for receipt within the receiving portion. The collar can be positioned as a stop member along the vertical post portion to define the extent of travel of the vertical post portion within the receiving portion.

The first substantially horizontal member includes a first end and a second end, the first end being in communication with the second end of the vertical post portion. The first substantially horizontal member can be positioned at a plurality of angles and positions relative to the workpiece. The second substantially horizontal member includes a first end and a second end, the first end being in communication with the second end of the first substantially horizontal member. The second substantially horizontal member can also be positioned at a plurality of angles and positions relative to the workpiece. The lengths of the first and second substantially horizontal members can vary depending on the shape and configuration of the workpiece.

The present toolrest has a number of advantages over conventional toolrests including one-piece construction and allowing the operator to engage the workpiece from a wide range of positions and angles so that the operator can seamlessly transition a tool from one portion of the workpiece to another portion of the workpiece without moving or adjusting the toolrest.

### BRIEF DESCRIPTION OF THE DRAWINGS

These and other features, aspects and advantages of the present invention will become better understood with reference to the following description, appended claims and accompanying drawings wherein:

FIG. 1 is an oblique elevational perspective view of a preferred embodiment of the toolrest of the present invention;

FIG. 2 is a side elevational view of the toolrest;

FIG. 3 is a rear view of the toolrest;

FIG. 4 is a front elevational view of the toolrest;

FIG. 5 is a front view of the adjustable collar and locking lever; and

FIG. 6 is a front view of the toolrest.

### DETAILED DESCRIPTION OF THE INVENTION

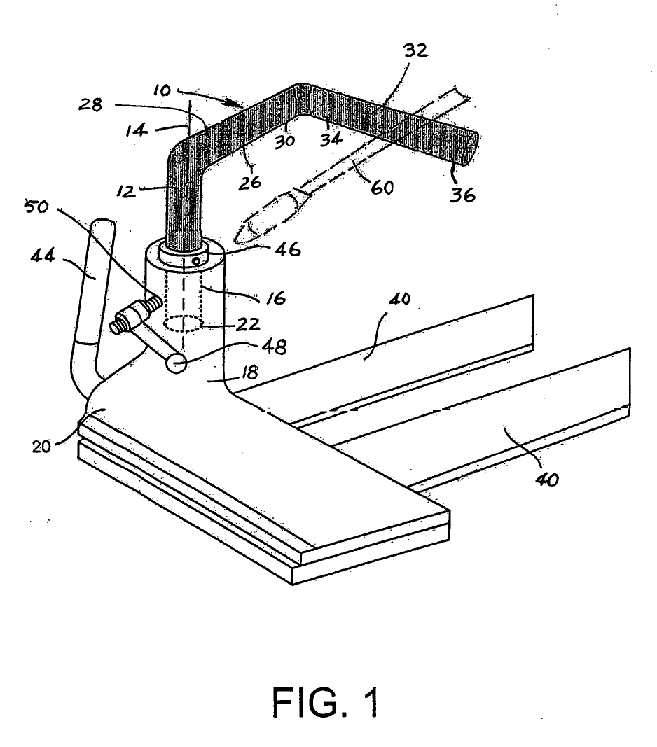

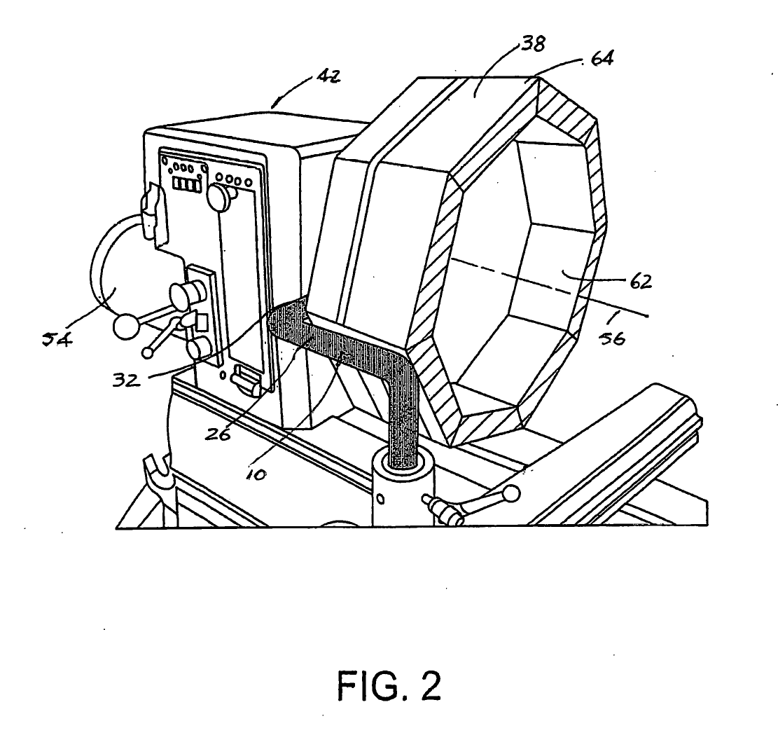

Referring to FIG. 1, a toolrest 10 includes a vertical post portion 12 that can be adjustably and slidably mounted about a vertical axis 14 within a bore 16 defined in a receiving portion 18 of a lathe tool carriage 20. The vertical post portion 12 includes a first end 22 and a second end 24. The first end of the vertical post portion 22 is received within the bore 16 of the receiving portion 18. A first substantially horizontal member 26 includes of a first end 28 and a second end 30. The first end of the first substantially horizontal member 28 extends at a first angle of about 90 degrees relative to the second end of the vertical post portion 24. A second substantially horizontal member 32 includes a first end 34 and a second end 36. The first end 34 of the second substantially horizontal member 32 extends at a second angle of about 90 degrees relative to the second end 30 of the first substantially horizontal member 26. The lengths of the first substantially horizontal member 26 and the second substantially horizontal member 32 can vary depending on the shape and configuration of a workpiece 38. (See FIG. 2). The lathe tool carriage 20 is slidably mounted on rails 40 of a lathe 42 and locked in position by a lever arm 44. (See FIG. 2).

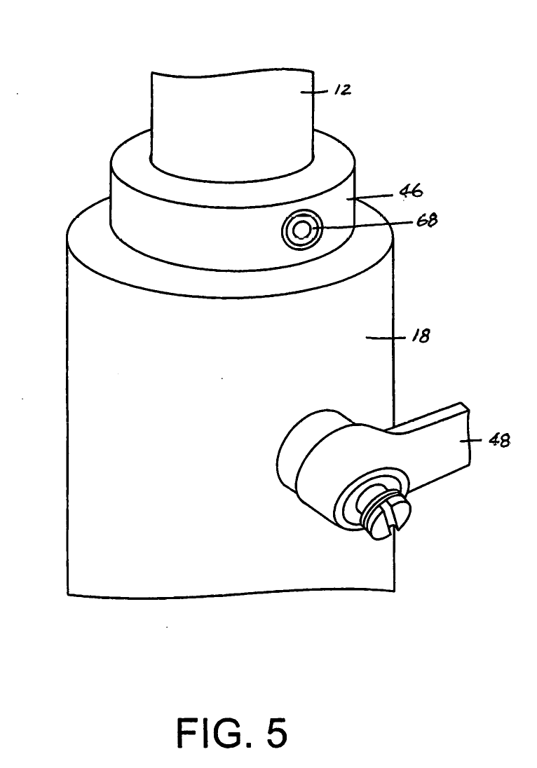

The vertical post portion 12 can include an adjustable set-screw collar 46 (see FIG. 5) for engaging the receiving portion 18 and limiting the extent of travel of the vertical post portion 12 within the receiving portion 18. A threaded portion of a locking lever 48 extends through a corresponding threaded channel 50 defined in the receiving portion 18 to engage the vertical post portion 12 and firmly position the toolrest 10 in various adjusted positions. The toolrest 10 may be adjusted at various heights and angles relative to the workpiece through engagement of the locking lever 48. The set-screw collar 46 acts as a stop member to allow the first substantially horizontal member 26 and the second substantially horizontal member 32 of the toolrest 10 to pivot about the vertical axis 14 while maintaining the height of the toolrest relative to the receiving portion 18 of the lathe tool carriage 20 and the workpiece 38. (See FIG. 2).

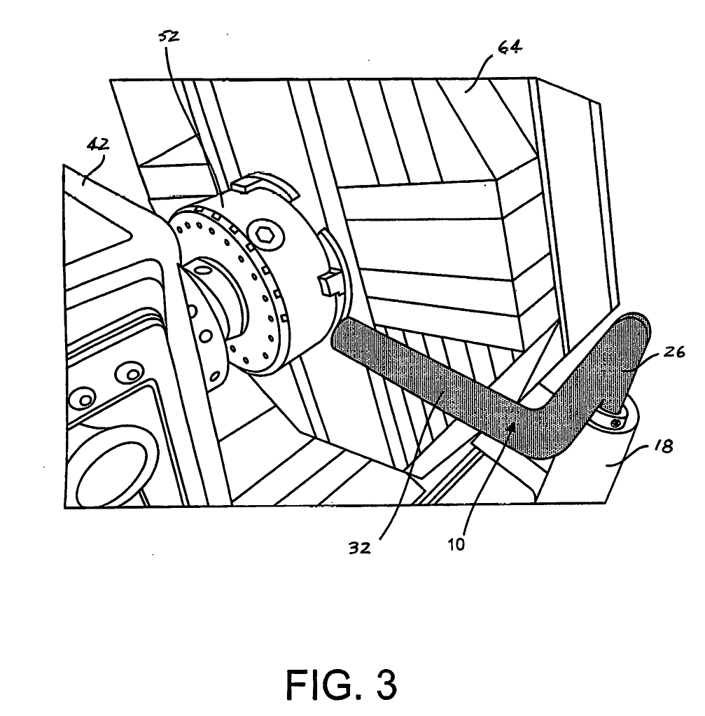

The toolrest 10 is preferably used as follows. The operator mounts the workpiece 38 (which can comprise a solid block of wood or a segmented workpiece, as shown) on the lathe 42 in a conventional manner. (See FIG. 2). The workpiece 38 is releasably mounted by a chuck 52 of the lathe 42. (See FIG. 3). A motor 54 transfers power to the lathe 42 causing the chuck 52 to rotate at a high rate of speed. (See FIGS. 2 and 3). The chuck 52 turns the workpiece 38 about a central horizontal axis 56 of the lathe 42. (See FIGS. 2 and 3). A central horizontal axis 58 of the workpiece 38 and the central horizontal axis 54 of the lathe 42 are identical to the central horizontal axis 58 of the chuck 52. (See FIGS. 2, 3 and 4).

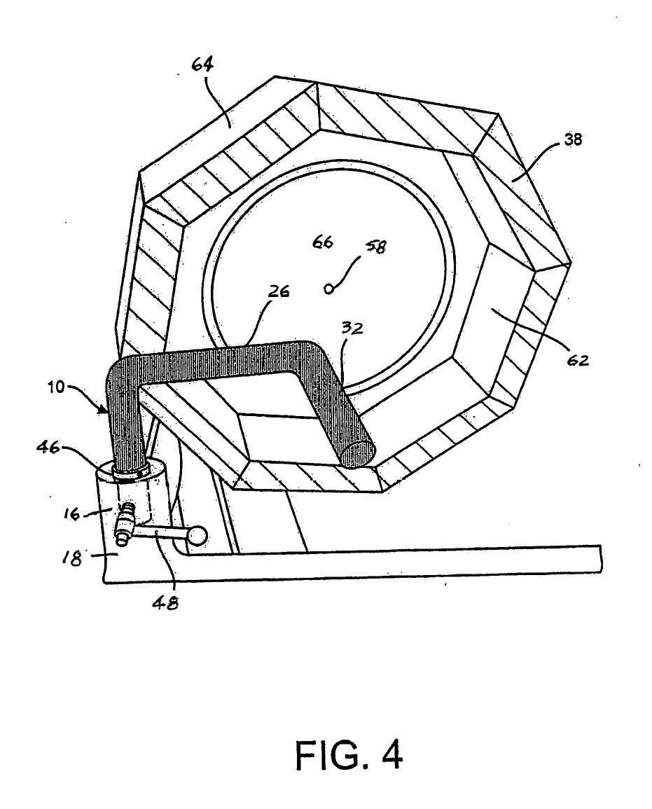

The toolrest 10 can be adjustably mounted within the receiving portion and through engagement of the locking lever 48, whereby rotation of the locking lever 48 securely holds the toolrest 10 in place. By selective adjustment of the locking lever 48 and the set-screw collar 46, the operator can position the toolrest 10 to various positions and angles. A cutting tool 60 can be positioned relative to either the first substantially horizontal member 26 or the second substantially horizontal member 32 of the toolrest 10. (See FIG. 1). The upper portion of the first substantially horizontal member 26 and the upper portion of the second substantially horizontal member 32 can include flat surfaces (not shown) so the operator can better support a cutting tool 60 in a stable position on the toolrest 10. (See FIG. 1). Symmetrical cuts are made to the workpiece 38 when an operator applies the cutting tool 60 to the inner surface 62, outer surface 64 and/or bottom surfaces 66 of workpiece 38 as the workpiece 38 turns around a central horizontal axis 58 thereby shaping the workpiece 38. (See FIGS. 1 and 4). The first substantially horizontal member 26 and the second substantially horizontal member 32 may be positioned about the vertical axis 14 to keep the cutting tool 60 consistently close to the workpiece 38 and to reduce cutting tool 60 vibration. (See FIG. 1).

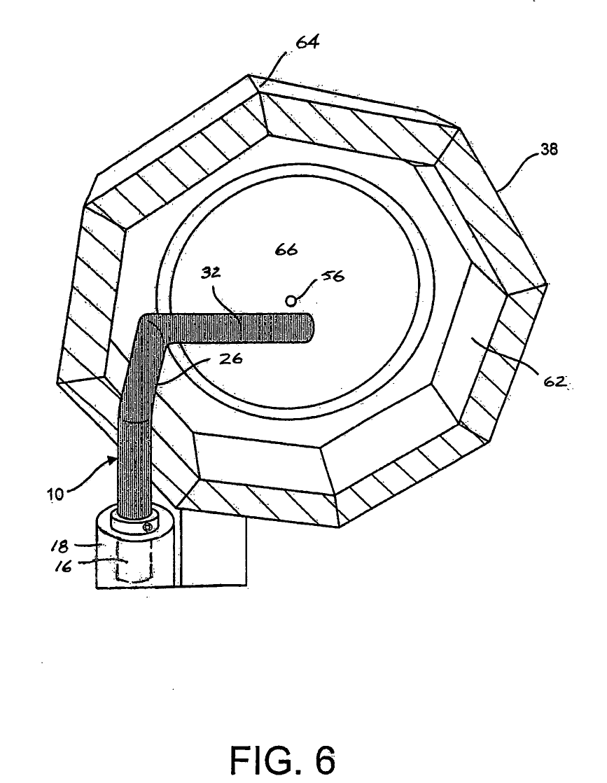

FIGS. 2 and 3 disclose the toolrest 10 positioned so that an operator can rest the cutting tool 60 (see FIG. 1) against the first substantially horizontal member 26 and/or the second substantially horizontal member 32 to engage the outer surface 64 and/or bottom surfaces 66 of the workpiece 38. (See FIGS. 4 and 6). The first substantially horizontal member 26 and second substantially horizontal member 32 are positioned adjacent to the workpiece 38. The first substantially horizontal member 26 is parallel to the outer surface 64 of the workpiece 38, thus allowing the operator to use the cutting tool 60 (see FIGS. 1, 4 and 6) to engage and thereby form the workpiece 38. The operator can further shape the bottom surface 66 of the workpiece 38 by placing the tool 60 (see FIGS. 1, 4 and 6) on the second substantially horizontal member 32. The 90-degree angle turns of the one-piece metal construction (preferably alloy steel) and the rotational movement of the toolrest 10 around the vertical axis 14 allow the operator to safely and accurately employ a cutting tool 60 (see FIG. 1) to engage the workpiece 38 in a multiple of positions and angles. As a result, the operator can safely employ the cutting tool 60 to engage both the inner surface 62 and the outer surface 64 of the workpiece 38. (See FIGS. 1, 4 and 6).

FIGS. 4 and 6 further demonstrate the versatility of the invention. The locking lever 48 associated with the receiving portion 18 can be positioned to allow rotation of the toolrest 10 within the bore 16 of the receiving portion 18. Rotation of the toolrest 10 about the vertical axis 14 provides the operator with multiple angles whereby to engage the workpiece 38 with the cutting tool 60 (see FIG. 1) as the workpiece 38 rotates about a central horizontal axis 58. The locking lever 48 attached to the receiving portion 18 may be adjusted to allow horizontal rotation of the toolrest 10 about the vertical axis 14 to allow the operator to engrave the workpiece 38 along a horizontal plane. The locking lever 48 associated with the receiving portion 18 may be used to position the toolrest 10 in the desired position relative to the workpiece 38 to reduce vibration of the cutting tool 60 (see FIG. 1) placed upon the toolrest 10. In FIG. 4, the second substantially horizontal member 32 is positioned substantially parallel to the central horizontal axis 56 of the lathe 42 and the first substantially horizontal member 26 is substantially perpendicular to the central horizontal axis 56 of the lathe 42.

Referring to FIG. 5, an enlarged view of the set-screw collar 46 and locking lever 48 relative to the toolrest 10 and receiving portion 18 of the lathe tool carriage is shown. The set-screw collar 46 includes a threaded set screw 68 positioned within and extending through a corresponding threaded passage (not shown) of the set-screw collar 46 for maintaining the height of the toolrest 10 relative to the receiving portion 18 and thus the workpiece 38.

In FIG. 6, the first substantially horizontal member 26 is positioned substantially parallel to the central horizontal axis 56 of the lathe 42 and the second substantially horizontal member 32 is positioned substantially perpendicular to the central horizontal axis 56 of the lathe 42, thus providing additional angles and positions for engaging the workpiece 38 with the cutting tool 60. (See FIG. 1). In view of the increased range of positions and angles of the toolrest 10 relative to conventional toolrests, the operator is able, for example, to engage the inner surface 62 of the workpiece 38 and the bottom surface 66 of the workpiece 38.

Although the embodiments described herein primarily apply to woodturning lathes, it will readily be appreciated by those skilled in the art that the invention may be applied to other types of lathes including those used for metal working. Thus, the foregoing description should not be construed as limiting the invention to the embodiments described or to lathes suitable only for woodturning.

What is claimed is:

1. A toolrest for adjustable mounting within a receiving portion of a lathe tool carriage relative to a workpiece comprising:
a vertical post portion adapted for vertical and rotational movement within the receiving portion;
a first substantially horizontal member extending at a first angle of about 90 degrees relative to the vertical post portion; and
a second substantially horizontal member extending at a second angle of about 90 degrees relative to the first substantially horizontal member;
whereby, upon adjustable mounting of the toolrest within the receiving portion, the first and second substantially horizontal members define a plurality of toolrest positions relative to the workpiece.

2. The toolrest according to claim 1 wherein the vertical post portion includes a collar for engaging the receiving portion to define the extent of travel of the vertical post portion within the receiving portion.

3. The toolrest according to claim 1 wherein the vertical post portion includes a first end and a second end, the first end adapted for receipt within the receiving portion.

4. The toolrest according to claim 3 wherein the first substantially horizontal member includes a first end and a second end, the first end being in communication with the second end of the vertical post portion.

5. The toolrest according to claim 4 wherein the second substantially horizontal member includes a first end and a second end, the first end being in communication with the second end of the first substantially horizontal member.

6. The toolrest according to claim 1 wherein the first substantially horizontal member can be positioned at a plurality of angles relative to the workpiece.

7. The toolrest according to claim 1 wherein the second substantially horizontal member can be positioned at a plurality of angles relative to the workpiece.

8. A one-piece toolrest for adjustable mounting within a receiving portion of a lathe tool carriage relative to a workpiece comprising:
a vertical post portion having a first end and a second end, the first end being adapted for vertical and rotational slidable movement within the receiving portion;
a first substantially horizontal member having a first end and a second end, the first end associated with the second end of the vertical post portion, the first substantially horizontal member extending at a first angle of about 90 degrees relative to the vertical post portion; and
a second substantially horizontal member having a first end and a second end, the first end associated with the second end of the first substantially horizontal member, the second substantially horizontal member extending at a second angle of about 90 degrees relative to the first substantially horizontal member;
whereby, upon adjustable mounting of the toolrest within the receiving portion, the first and second substantially horizontal members define a plurality of toolrest positions relative to the workpiece.

9. The toolrest according to claim 8 wherein the vertical post portion includes a collar for engaging the receiving portion to define the extent of travel of the vertical post portion within the receiving portion.

10. The toolrest according to claim 8 wherein the first and second substantially horizontal members can be positioned at a plurality of angles relative to the workpiece.
